(19) United States
(12) Patent Application Publication
(10) Pub. No.: US 2011/0058378 A1
(43) Pub. Date: Mar. 10, 2011

(54) Illumination Device with High Efficiency and Manufacture Method Thereof

(75) Inventors: Kuang-Hua Mei, Hsin-Chu (TW); Yiwen Chen, Hsin-Chu (TW); Hao-Liang Chao, Hsin-Chu (TW); Ci-Guang Peng, Hsin-Chu (TW)

(73) Assignee: AU OPTRONICS CORPORATION, Hsin-Chu (TW)

(21) Appl. No.: 12/834,984

(22) Filed: Jul. 13, 2010

(30) Foreign Application Priority Data
Sep. 4, 2009 (TW) 098129901

(51) Int. Cl. F21V 7/00; F21V 5/04; B29D 11/00

(52) U.S. Cl. 362/296.01; 362/311.06; 264/1.1

(57) ABSTRACT

An illumination device and a manufacture method thereof are provided. The illumination device includes a base, an illumination chip, and a sealant. The base has a surrounding side wall which encloses a containing space. The illumination chip is disposed within the containing space while the sealant fills the containing space and covers the illumination chip. The sealant has an outer surface which includes a center concave and a circular convex surrounding the center concave. The center concave is formed as a part of a spherical surface with no singular point. The connection between the center concave and the circular convex forms a circular ridge.

### BACKGROUND OF THE INVENTION

1. Field of the Invention

The present invention generally relates to an illumination device and a manufacture method thereof. Particularly, the present invention relates to an illumination device and a manufacture method thereof to prevent the light from overly centralizing and increase the light use efficiency.

2. Description of the Prior Art

Display panels and display devices using the display panels gradually become a mainstream among a variety of display devices. For example, panel monitors of home flat-panel TV, personal computer, and laptop computer, display screens of mobile phone and digital camera are products which use a great deal of display panels. Particularly, the market demand for the liquid crystal display device rises rapidly in recent years, the design of the backlight module applied to the liquid crystal display device becomes diverse in order to fulfill the requirement of function and appearance.

For the pursuit of lighter size and smaller consumption of power, light-emitting diode (LED) elements have been largely used as the light source. Either edge-lighting or bottom-light backlight module can use LEDs as the light source. FIG. 1A shows a conventional LED element. As FIG. 1A shows, the conventional LED element includes a hollow base 10, inside which a light-emitting diode (LED) chip is deposited. The hollow base is further filled with a sealant 30 which covers the LED chip. The surface of the sealant can be usually formed as a plane surface, a concave surface or a convex surface. As FIG. 1A shows, because the refractive index of the sealant is greater than that of the air outside, the total reflection occurs easily when the light emitted from the light-emitting diode (LED) chip 20 to a plane or a concave surface 31 of the sealant at a greater incident angle. At this time, the light has to be reflected many times inside the sealant 30 before exiting, therefore the light use efficiency is reduced.

A conventional light-emitting diode (LED) element as FIG. 1B shows, the surface of the sealant 30 is formed as a convex surface. As a result of the geometric properties of convex surface, such a design can reduce the opportunity for total reflection. However, this conventional design centralizes light in a forward direction of the element. When such a design is in cooperation with the backlight module, thus affecting the image quality of the display device. Moreover, because the center of the convex surface of the sealant 30 is more protrudent and susceptible to contact with the light guide plate or other components and deform, affecting the performance of light output.

### SUMMARY OF THE INVENTION

It is an object of the present invention to provide an illumination device and a manufacture method thereof to increase the light use efficiency of the illumination device.

It is another object of the present invention to provide an illumination device and a manufacture method thereof to prevent light from overly centralizing.

It is another object of the present invention to provide an illumination device and a manufacture method thereof to provide a protection to the surface of the sealant.

The illumination device includes a base, an illumination chip, and a sealant. The base has a surrounding side wall which encloses a containing space; the illumination chip is disposed within the containing space while the sealant fills the containing space and covers the illumination chip. After filling the sealant in the containing space, the part of sealant exposed at the opening of the side wall forms an outer surface. The outer surface mainly includes two parts: a center concave and a circular convex. The circular convex surrounds the center concave as a ring; the center concave is formed as a part of a spherical surface with no singular point. A joint of the center concave and the circular convex forms a circular ridge.

The light emitted from the illumination chip passes through the sealant and exits, hence the shape of the outer surface of the sealant is the interface between the sealant and the external medium. Adoption of the center concave at the center position of the outer surface of the sealant makes light emitted therefrom more divergent, preventing the light from overly centralizing and enhancing the uniformity of light distribution. And the adoption of the circular convex at the periphery position of the outer surface of the sealant reduces the total reflection of light inside the sealant, increasing efficiency of illumination.

A manufacture method of the illumination device of the present invention includes the following steps: forming a base, wherein a surrounding side wall of the base encloses a containing space; disposing an illumination chip within the containing space; filling the containing space with a sealant covering the illumination chip; forming a center concave and a circular convex on the outer surface of the sealant which connects with the side wall. The circular convex surrounds the center concave, and a joint of the circular convex and the center concave forms a circular ridge, hence the step also needs to determine the circular ridge.

### BRIEF DESCRIPTION OF THE DRAWINGS

FIGS. 1A and 1B show schematic views of the conventional light-emitting diode (LED) element;

FIG. 2 is a cross-sectional view of the embodiment of the illumination device of the present invention;

FIG. 3A is a schematic view of the embodiment of the illumination device;

FIG. 3B is a cross-sectional view of the embodiment shown in FIG. 3A;

FIG. 3C is a cross-sectional view of another embodiment;

FIG. 4 shows a light path of the embodiment of the illumination device;

FIG. 5 shows a light path of another embodiment of the illumination device;

FIG. 6 is a schematic view of the geometry of the center concave;

FIG. 7 is a cross-sectional view of another embodiment of the illumination device;

FIG. 8 is a flow chart of the embodiment of the manufacture method of the illumination device;

FIG. 9 shows a light path of the sealant when its thickness is changed.

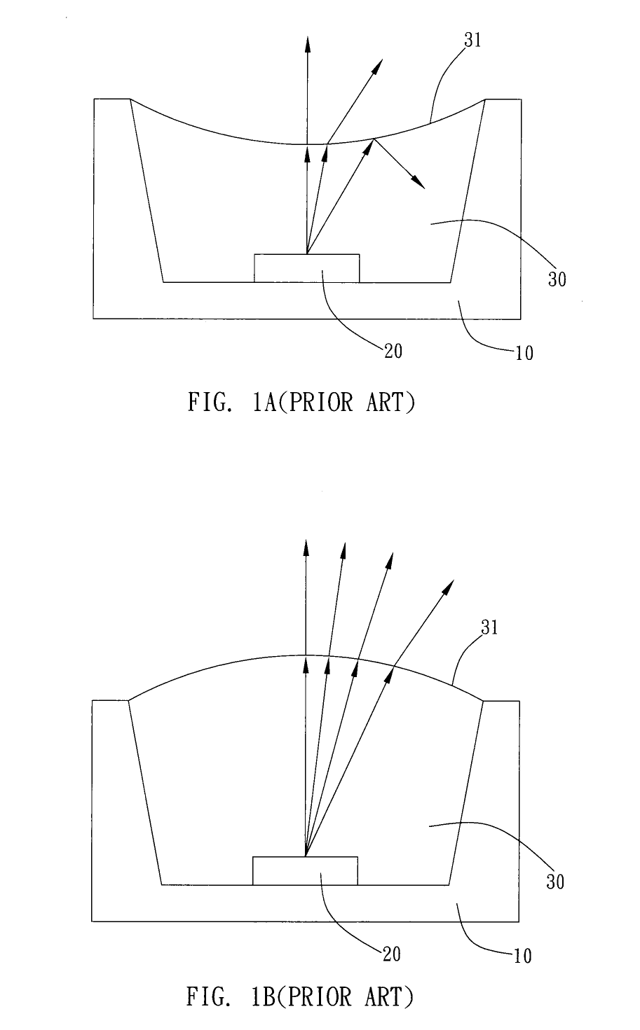

### DETAILED DESCRIPTION OF THE PREFERRED EMBODIMENT

The present invention provides an illumination device, and a manufacture method thereof, and a backlight module using the same. In a preferred embodiment, the illumination device is an illumination device consisting of light-emitting diode (LED). In other embodiments, however, the diode chip of the light-emitting diode (LED) can be replaced with other illumination mechanism. Besides, in a preferred embodiment, the backlight module is provided for use in the liquid crystal display (LCD) device. In other embodiments, however, the backlight module can be provided for use in PC keyboard, mobile phone keys, billboard, and other devices which need a plane light source. Furthermore, the present invention includes a liquid crystal display (LCD) device using the illumination device and the backlight module. In a preferred embodiment, the liquid crystal display device of the present invention includes a color liquid crystal display device. In another embodiment, however, the liquid crystal display device of the present invention can include a mono liquid crystal display device. Moreover, the liquid crystal device broadly refers to any display device using the liquid crystal panel, which includes a home LCD TV, LCD monitors for PC and laptop computer, liquid crystal display panels of mobile phone and digital camera.

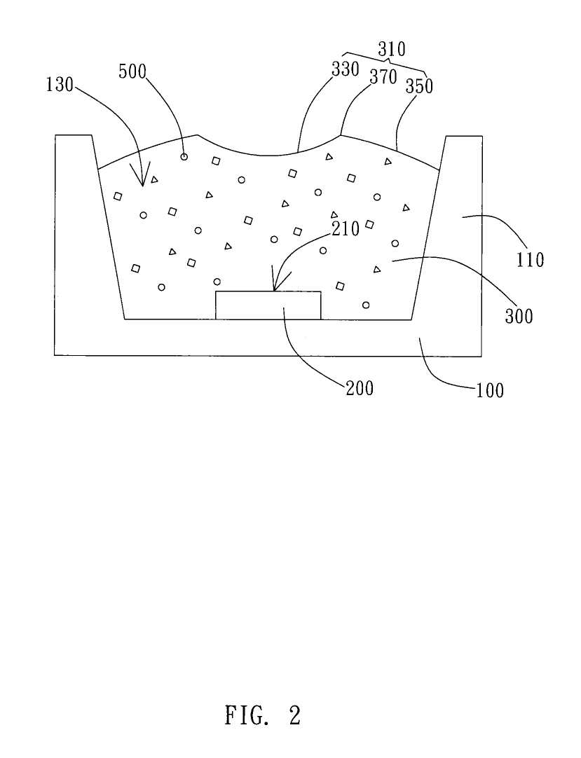

As FIG. 2 shows, the illumination device includes a base 100, an illumination chip 200, and a sealant 300. The base 100 has a surrounding side wall 110 which encloses a containing space 130. In a preferred embodiment, the side wall 110 includes four faces cross to each other to form the containing space 130 of hexahedron. In another embodiment, however, the side wall presents a ring form to enclose the containing space 130 as a cylinder or a cone. As FIG. 2 shows, the inner side of the side wall preferably inclines inwardly so that the containing space 130 has a greater caliber at the position near the opening.

As FIG. 2 shows, the illumination chip 200 is disposed in the containing space 130 enclosed by the side wall 110 and on the base 100. In a preferred embodiment, the illumination chip 200 includes a least one illumination chip made of diode die; in other embodiments, however, the light-emitting diode (LED) chip may be replaced with other illumination mechanism to serve as the illumination chip 200. The illumination chip 200 preferably lies in the containing space 130 with an illumination top surface 210 facing the opening of the containing space 130. The illumination top surface 210 is preferably a rectangular plane, but it can be a plane of other shapes or a curved surface according to the form of the illumination chip 200.

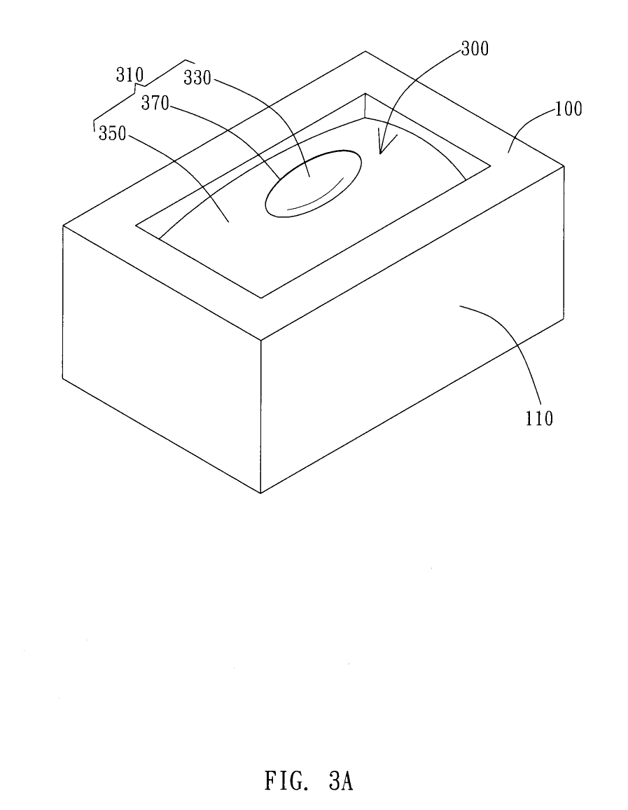

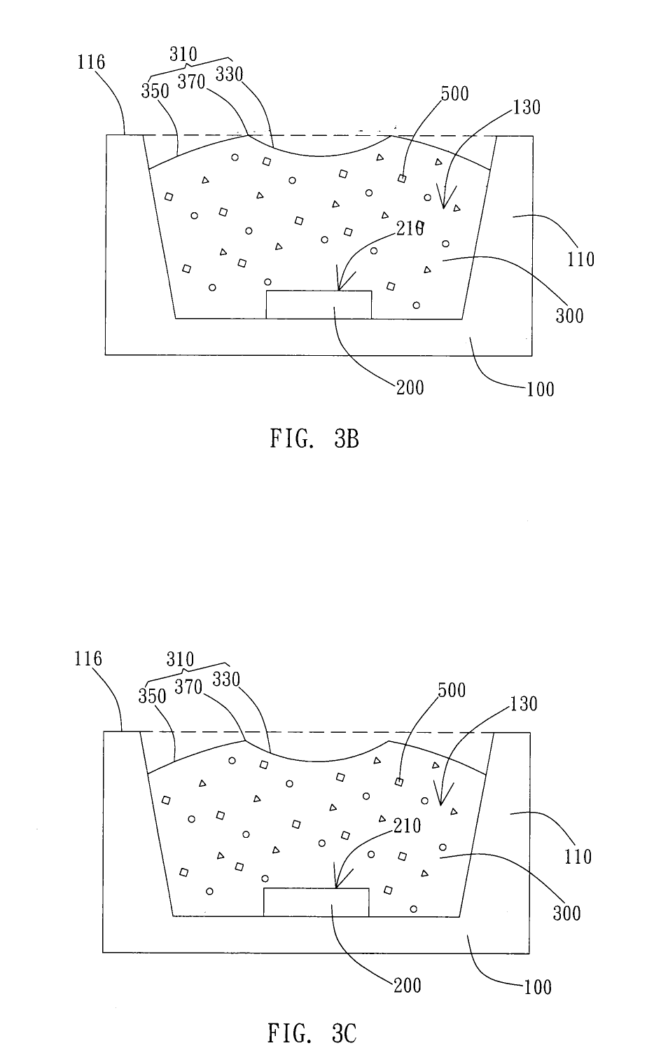

In the embodiment shown in FIG. 2, the sealant 300 fills the containing space 130 and covers the illumination chip 200. The sealant 300 can be solid sealant or liquid sealant. The material of the sealant 300 can be epoxy resin, silicone resin or other polymer material. Furthermore, the sealant 300 can be added with suitable mixtures, such as phosphor powders 500, to meet the requirement of color and brightness. As FIG. 2 shows, after filling the sealant 300 in the containing space 130, the part of sealant 300 exposed at the opening of the side wall 110 forms an outer surface 310. As FIG. 2 and FIG. 3A show, the edge of the outer surface 310 connects with the inner side or the top of the side wall 110. The outer surface 310 mainly includes two parts: a center concave 330 and a circular convex 350. The circular convex 350 surrounds the center concave 330 as a ring. With respect to the inside of the sealant 300, the circular convex 350 protrudes outward and is preferably a part of spherical surface with no singular point (except for the edge position). In a preferred embodiment, the circular convex 350 is formed as a part of a convex spherical surface. The spherical surface can include a circular spherical surface, an elliptic spherical surface, or a spherical surface in other forms.

As FIG. 2 and FIG. 3A show, the center concave 330 is formed as a part of a concave spherical surface with no singular point (except for the edge position). The spherical surface described here can include a circular spherical surface, an elliptic spherical surface, or a spherical surface in other forms. The outer rim of the center concave 330 connects with the inner rim of the circular convex 350 and is surrounded by the inner rim of the circular convex 350. Because the center concave 330 is an inward concave and the circular convex 350 is an outward convex, the joint of the center concave 330 and the circular convex 350 forms a circular ridge 370, as the perspective view shown in FIG. 3A. As the cross-sectional view of FIG. 2, the circular ridge 370 forms a tip point.

In a preferred embodiment, as FIG. 3B shows, the circular ridge 370 is aligned with the level where the top 116 of the side wall 110 exists. In other words, the circular ridge 370 does not protrude over the side wall 110 and is contained in the containing space 130. With such a design, the most protrudent part of the outer surface 310 of the sealant 300 is prevented from contacting with the light guide plate or other components and the deformation of the sealant 300 is also prevented. Furthermore, as the embodiment shown in FIG. 3C, the circular ridge 370 can lower than the level where the top 116 of the side wall 110 exists and protected by the top 116 of the side wall 110. But in another embodiment, the circular ridge 370 can protrude over the top 116 of the side wall 110.

In the above embodiment, light emitted from the illumination chip 200 passes through the sealant 300 to exit. Therefore, the shape of the outer surface 310 of the sealant 300 is the interface between the sealant 300 and the external medium (for example, the air), and affect the behavior of the light. Adoption of the center concave 330 at the center position of the outer surface 310 of the sealant 300 makes the light emitted therefrom more divergent, preventing the light from overly centralizing and enhancing the uniformity of light distribution. And the adoption of the circular convex 350 at the periphery part of the outer surface 310 of the sealant 300 reduces total reflection of light inside the sealant 300, increasing efficiency of illumination. Furthermore, the concave design in the center part of the outer surface 310 of the sealant 300 reduces the degree of protrusion of the outer surface 310, further decreasing the possibility of contacting with other components and becoming deformed.

For different effects, the geometric properties of the center concave 330 and the circular convex 350 can be adjusted, such as a radius of curvature and a radius of the projection area of the curved surface. Furthermore, the connecting position of the center concave 330 and the circular 350, i.e. the position of the circular ridge 370, can also be adjusted. For example, the position of the projection of the circular ridge 370 can be completely or partially within the illumination top surface 210 of the illumination chip. However, in another embodiment, the position of the projection of the circular ridge 370 can be outside the illumination top surface 210.

As the embodiment shown in FIG. 4, the position of a center 211 is defined on the illumination top surface 210. At the center 211, a center normal line 217 is vertical to the illumination top surface 210 of the illumination chip 200. When determining the position of the circular ridge 370, the light emitted from the center 211 serves as a reference of determining the position of the circular ridge 370. In other words, a distance exists between the center normal line 217 and the position at which the light emitted from the center 211 strikes the center concave 330. The nearer the incident light to the center normal line 217 is, the smaller the angle of refraction will be; the farther the incident light away from the center position of the center concave 330 is, the greater the angle of refraction will be. When the light striking the center concave 330 has an angle of refraction of 90-degrees, the total reflection will occur. In this case, the position of the center concave 330 is defined as the edge of the center concave 330, i.e. the position where the circular ridge 370 exists. In other words, because the total reflection of light emitted from the center 211 occurs at the position which is beyond the circular ridge 370, the part of the outer surface 310 where total reflection occurs is replaced with the circular convex 350 to avoid the occurrence of total reflection and increase light use efficiency. When the light strikes the circular convex 350 which is outside the circular ridge 370, the light can exit without occurring total reflection as a result of the reverse of the direction of the center normal line of the interface with respect to the normal line of the center concave 330.

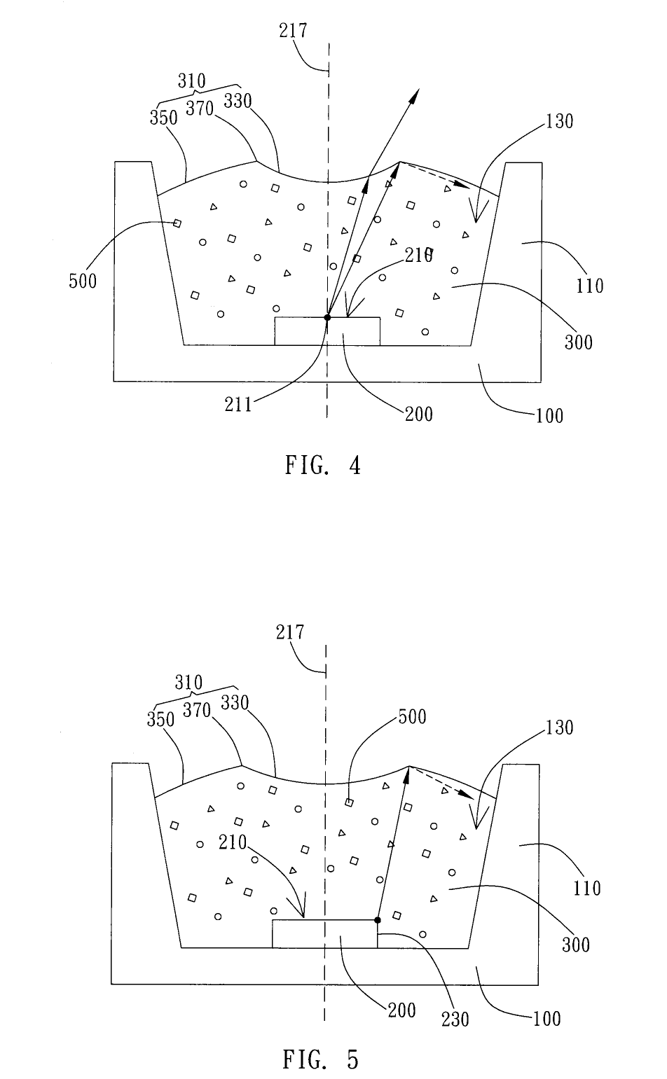

In another embodiment different from that shown in FIG. 4, when determining the position of the circular ridge 370, the light emitted from a different poison of the illumination top surface 210 or the side wall of the illumination chip 200 can serve as the reference light for determining the position of the circular ridge 370. As FIG. 5 shows, the light emitted from the position nearby the edge of the illumination top surface 210 serve as the reference light. The position of the reference light can be generated on the illumination top surface 210, the edge of the illumination top surface or a side wall 230 of the illumination chip 200. Similar to the embodiment shown in FIG. 4, the position where the total reflection of the reference light occurs on the center concave 330 is determined to be the position of the circular ridge 370. Especially, as FIG. 5 shows, the center normal line 217 of the illumination chip 20 divides the radial cross section shown in FIG. 5 into a left side and a right side. The position of the circular ridge 370 on the left side is determined by the reference light emitted from the left side edge of the illumination chip 200; and the position of the circular ridge 370 on the right side is determined by the reference light emitted from the right side edge of the illumination chip 200. Besides, the position of the circular ridge 370 of every radial cross section is determined by the reference light emitted from edge of the illumination chip 200 in every radial cross section. When the position of the circular ridge 370 of every radial cross section is determined, the positions of every circular ridge 370 can make a complete closed circular ridge 370.

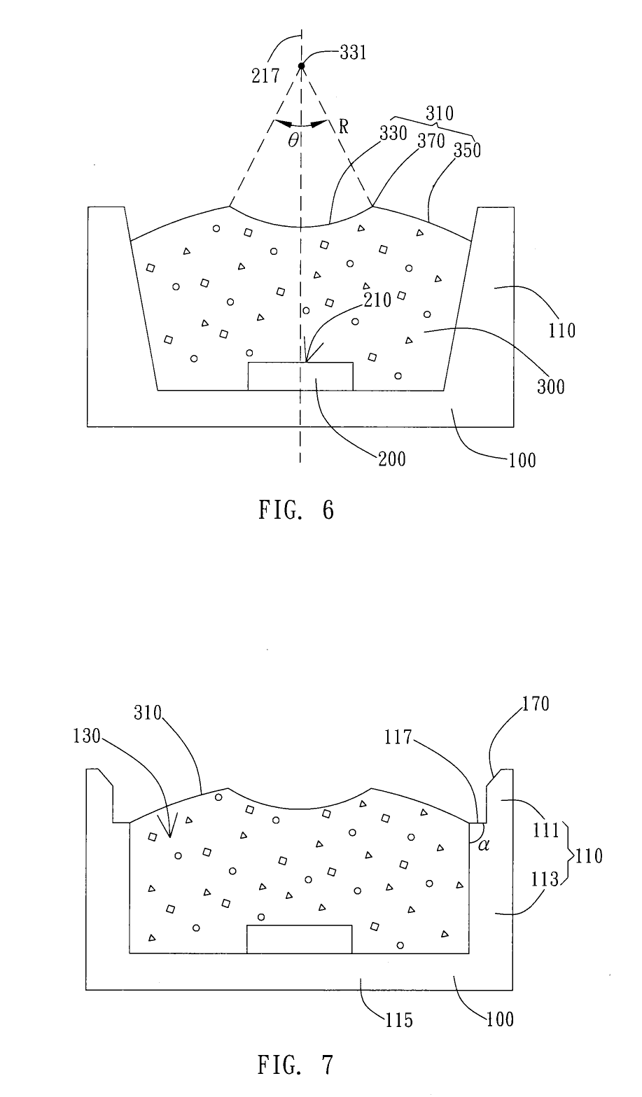

As FIG. 6 shows, in a preferred embodiment, the center concave 330 has a virtual center of curvature 331. The center of curvature 331 is on the extension of the center normal line 217 which passes through the center 330. Two lines connecting the center of curvature 331 and the edge of the center concave 330, i.e. the circular ridge 370, meet at the center of curvature 331 to form a central angle θ. The central angle θ is between 5 and 30 degrees. Furthermore, the radius of curvature R of the center concave 330 with respect to the center of curvature 331 is preferably between 0.5 mm and 5 mm.

As FIG. 7 shows, the side wall 110 of the base 100 can be divided into an upper side wall 111 and a lower side wall 113. The lower end of the lower side wall 113 is connected to a bottom 115 of the base 100; the upper end of the lower side wall 113 is connected to the lower end of the upper side wall 111. As FIG. 7 shows, the lower side wall 113 is thicker than the upper side wall 111, hence the lower side wall 113 protrudes toward the containing space 130 over the inner surface of the upper side wall 111, and then forms a flange 117 on the lower end of the upper side wall 111. The included angle α between the flange 117 and the inner surface of the lower side wall 113 is preferably smaller than or equal to 90 degrees. When disposing the sealant 300, the edge of the outer surface 310 of the sealant 300 connects to a connection edge of the flange 117 and the inner surface of the lower side wall 113. Because the included angle α between the flange 117 and the inner surface of the lower side wall 113 is smaller than or equal to 90 degrees, a better surface tension can be provided to the outer surface 310 of the sealant 300.

As FIG. 7 shows, the position of the circular ridge 370 is preferably lower than the top of the upper side wall 111. By such as design, the upper side wall 111 can protect the outer surface 310 of the sealant 300 and prevent the most protrudent part of the outer surface 310 of the sealant 300 from contacting the light guide plate or other components and becoming deformed. In the embodiment, as FIG. 7 shows, the inner top surface of the upper side wall 111 is formed with an outward slope to form a lead angle. By the disposed lead angle, the hindrance of the upper side wall 111 to the light emitted out is reduced, and the exit angle of the light is increased.

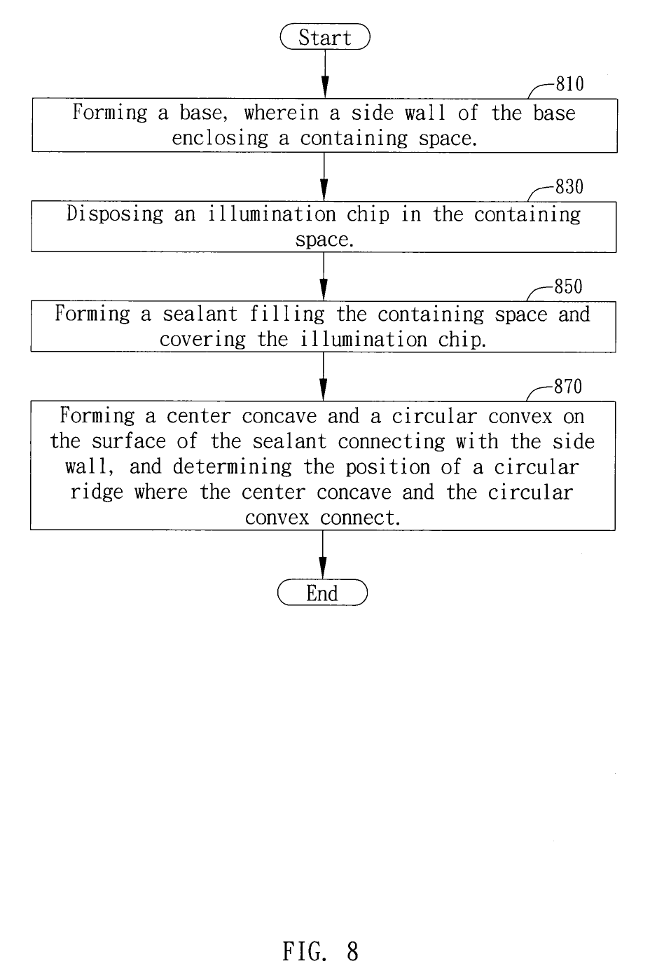

The present invention also includes a manufacture method of the illumination device. As the flow chart of the embodiment shown in FIG. 8, a step 810 includes: forming a base, wherein the side wall of the base enclosing a containing space. In a preferred embodiment, the base is formed by injection molding; however, in other embodiments, the base may be produced by other manufacture processes. A step 830 includes: disposing an illumination chip in the containing space. In a preferred embodiment, the illumination chip is made of light emitting diode die; in other embodiments, however, the illumination chip may be formed by other materials.

A step 850 includes: forming a sealant in the containing space covering and covering the illumination chip in the containing space. In a preferred embodiment, the containing space is filled with the sealant by injecting liquid material and then curing the sealant by UV curing, thermosetting, or other curing methods. Besides, when injecting the sealing material, the volume of the sealant is preferable controlled so that the height of the sealant is not over the top of the side wall after the sealant is cured.

A step 870 includes: forming a center concave and a circular convex on the surface of the sealant connecting with the side wall. The circular convex surrounds the center concave; the joint of the circular convex and the center concave forms a circular ridge. Hence, the step also needs to determine the position of the circular ridge. In a preferred embodiment, the form of the center concave can be made by molding the center position of the outer surface of the sealant with a mold with a convex spherical surface, and then curing the sealant by UV curing, thermosetting or other curing methods. However, in other embodiments, the center concave of the outer surface of the sealant can be formed by polishing or other methods after curing.

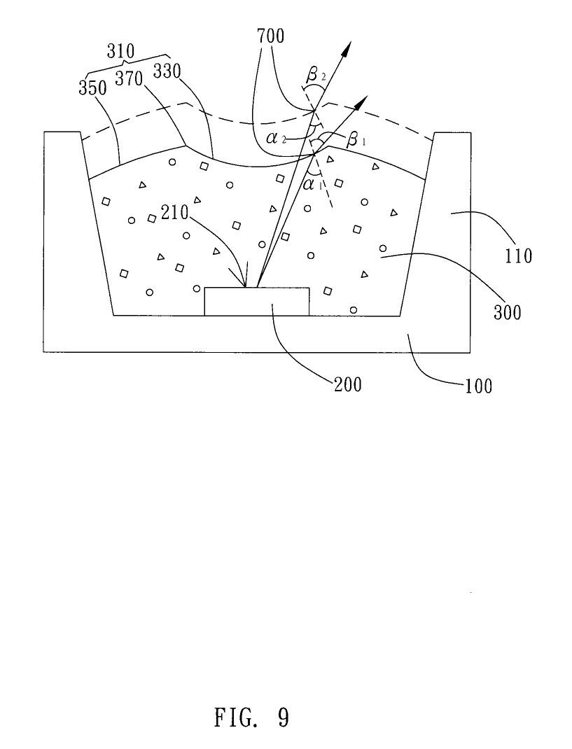

In step 870, for deciding the size of the center concave, the position of the circular ridge has to be determined. In a preferred embodiment, the position of the circular ridge is determined by the refractive index and the thickness of the sealant. Referring to both FIG. 4 and FIG. 5 and taking the center of the illumination top surface of the illumination chip as the emission point if the reference light, because the refractive index of the sealant affects the angle of refraction when the light exits the center concave, the position where total reflection occurs can also be affected. The greater the refractive index of the sealant is, the greater the angel of refraction will be obtained as the light exits the center concave. In other words, the position where total reflection occurs on the center concave is closer to the center of the center concave. At this time the position of the circular ridge is closer to the center of the center concave; and vice versa. Besides, as FIG. 9 shows, when the thickness of the sealant increases and the refractive index is constant with regard to a same projection point 700 on the center concave 330, because of the geometrical relationship, the angle of incidence α₂ is smaller than the original angle of incidence α₁, thereby the angle of refraction β₂ is also smaller than the original angle of refraction β₁. In other words, the position where total reflection occurs and the position of the corresponding circular ridge 370 are accordingly farther away from the center of the center concave 330.

Furthermore, in another embodiment, the radius of curvature and the central angle existing at the center of curvature can be determined according to the refractive index and the thickness of the sealant 300. As described above, the refractive index and the thickness of the sealant 300 can both affect the position where the total reflection occurs on the center concave. In the embodiment mentioned above, the spherical properties of the center concave 330, such as the radius of curvature, have not been adjusted. However in the present embodiment, the radius of curvature and the central angel existing at the corresponding center of curvature can be adjusted to respond to the refractive index and thickness of different sealants. When the radius of curvature of the center concave 330 is smaller and the thickness of the sealant is constant, the position where total reflection occurs is closer to the center of the center concave. In such a case, it is considerable to use the sealant 300 with greater thickness or smaller refractive index, so that the position of the circular ridge 370, i.e. where total reflection occurs, is farther away from the center of the center concave 330.

Although the preferred embodiments of present invention have been described herein, the above description is merely illustrative. The preferred embodiments disclosed will not limited the scope of the present invention. Further modification of the invention herein disclosed will occur to those skilled in the respective arts and all such modifications are deemed to be within the scope of the invention as defined by the appended claims.

What is claimed is:

1. An illumination device, comprising:
a base with a surrounding side wall enclosing a containing space;
an illumination chip disposed in the containing space; and
a sealant filling the containing space and covering the illumination chip, the sealant having an outer surface connecting with the side wall and including a center concave and a circular convex surrounding the center concave, a joint of the circular convex and the center concave forming a circular ridge,
wherein the center concave is formed as a part of a spherical surface with no singular point.

2. The illumination device of claim 1, wherein the sealant contains phosphor.

3. The illumination device of claim 1, wherein the illumination chip has an illumination top surface, the circular ridge is a critical position where a light emitted from a center of the illumination top surface is totally reflected with respect to the center concave.

4. The illumination device of claim 1, wherein the illumination chip has an illumination top surface, the circular ridge is a position closest to where a light emitted from the edge of the illumination top surface is totally reflected with respect to the center concave.

5. The illumination device of claim 1, wherein a central angle exists at a center of curvature of the center concave with respect to the circular ridge, the central angle is between 5 degrees and 30 degrees.

6. The illumination device of claim 1, wherein the radius of curvature of the center concave is between 0.5 mm and 5 mm.

7. The illumination device of claim 1, wherein the circular convex is formed as a part of a spherical surface with no singular point.

8. The illumination device of claim 1, wherein the circular ridge is contained in the containing space and aligned with or lower than a top of the side wall.

9. The illumination device of claim 1, wherein the side wall includes an upper side wall and a lower side wall, wherein the lower side wall protrudes toward the containing space over the upper side wall and forms a flange, the flange and an inner face of the lower side wall make an included angle less than or equal to 90 degrees.

10. The illumination device of claim 9, wherein an outer rim of the circular convex is connected to a joined edge of the flange and the lower side wall.

11. A manufacture method of an illumination device, comprising:
forming a base, the base having a surrounding side wall enclosing a containing space;
disposing an illumination chip in the containing space;
forming a sealant filling the containing space and covering the illumination chip; and
forming a center concave and a circular convex surrounding the center concave on an outer surface of the sealant connecting with the side wall, a joint of the circular convex and the center concave forms a circular ridge,
wherein the center concave is formed as a part of a spherical surface with no singular point.

12. The manufacture method of claim 11, wherein the step of forming the center concave and the circular convex includes: determining a position of the circular ridge based on a refractive index and a thickness of the sealant.

13. The manufacture method of claim 12, wherein the step of determining the position of the circular ridge includes: calculating a critical position where a light emitted from a center of an illumination top surface is totally reflected with respect to the center concave, the critical position is determined to be the position of the circular ridge.

14. The manufacture method of claim 11, wherein the step of forming the center concave and the circular convex includes: determining a radius of curvature of the center concave and a central angle with respect to a center of curvature of the center concave based on a refractive index and a thickness of the sealant.

15. The manufacture method of claim 11, wherein the step of forming the sealant includes: enabling the circular ridge to be contained in the containing space without protruding over the top of the side wall.

16. The manufacture method of claim 11, wherein the step of forming the center concave and the circular convex includes:
molding the outer surface of the sealant into the center concave before curing the sealant; and
curing the sealant.
